(19) United States
(12) Patent Application Publication
(10) Pub. No.: US 2020/0393419 A1
(43) Pub. Date: Dec. 17, 2020

(54) UNDERWATER INSPECTION DEVICE AND FILTERING METHOD OF ITS ATTITUDE SENSOR

(71) Applicant: Hainan University, Haikou (CN)

(72) Inventors: Hui LI, Haikou (CN); Pengxiang LI, Haikou (CN)

(21) Appl. No.: 16/879,494

(22) Filed: May 20, 2020

(30) Foreign Application Priority Data
Jun. 12, 2019 (CN) 201910503652. X

(51) Int. Cl. G01N 29/265; F16L 55/28

(52) U.S. Cl. CPC G01N 29/265; F16L 2101/30; F16L 55/28

(57) ABSTRACT

The present invention discloses an underwater inspection device and a filtering method of its attitude sensor, and relates to the field of pipeline geographic information measurement technologies. The underwater inspection device includes a shooting apparatus configured to acquire underwater pipeline image information, and further includes an underwater thruster configured to provide impetus for the underwater inspection device, a depth sensor configured to detect an underwater depth, an attitude sensor configured to detect a three-dimensional motion attitude of the underwater inspection device, and an umbilical cable. The underwater inspection device is communicatively connected to a host computer through the umbilical cable to receive a control command sent by the host computer and send the acquired pipeline information to the host computer. According to the technical solution of the present invention, the underwater inspection device detects underwater pipeline information in real time to promptly discover pipeline damage and leakage.

### TECHNICAL FIELD

The present invention relates to the field of pipeline geographic information measurement technologies, and in particular, to an underwater inspection device and a filtering method of its attitude sensor.

### BACKGROUND

Pipelines are not only important carriers for transporting various onshore and underwater oil and gas resources, but also the fastest and most economical and reliable transportation method at present. However, most pipelines are buried underground or under the seabed at a certain depth. Underground pipelines are susceptible to terrain changes caused by man-made excavations and natural disasters. Submarine oil and gas pipelines work in complex marine environments. Subject to high pressure and salinity, large temperature differences, and erosion of biological growth for a long time, these pipelines can be easily corroded, damaged, and cracked. Failure to promptly detect pipeline damage can not only lead to huge economic losses, but also cause immeasurable damage to the marine ecological environment.

### SUMMARY

The objective of the present invention is to provide an underwater inspection device and a filtering method of its attitude sensor, to promptly discover underwater pipeline damage and leakage.

To achieve the foregoing objective, the present invention provides an underwater inspection device, including a shooting apparatus configured to acquire underwater pipeline image information. The underwater inspection device further includes an underwater thruster configured to provide impetus for the underwater inspection device, a depth sensor configured to detect an underwater depth, an attitude sensor configured to detect a three-dimensional motion attitude of the underwater inspection device, and an umbilical cable. The underwater inspection device is communicatively connected to a host computer through the umbilical cable to receive a control command sent by the host computer and send the acquired pipeline information to the host computer.

Preferably, the underwater inspection device includes a housing and a main control board and an expansion board that are disposed in the housing. The shooting apparatus is disposed on the main control board. The main control board and the shooting apparatus are disposed in a sealed tank. A battery configured to power the underwater inspection device is further disposed between the main control board and the expansion board. The battery is sealed in a battery compartment. Various sensors configured to detect a state of the underwater inspection device are disposed on the expansion board.

Preferably, the shooting apparatus is connected to the main control board by using a dual-axis digital steering engine.

Preferably, the shooting apparatus includes an underwater camera, a highlight LED, and a laser probe.

Preferably, the depth sensor is communicatively connected to the expansion board through a serial port of a universal asynchronous transceiver. The depth sensor saves the acquired information to a read-only memory on the expansion board for sending to the host computer.

Preferably, the underwater thruster includes three groups of brushless motors and numerically controlled four-blade forward and reverse propellers connected to the brushless motors. The first group of the underwater thruster and the second group of the underwater thruster are disposed at the tail of the underwater inspection device, so that the underwater inspection device can move forward, backward, leftward, and rightward. The third group of the underwater thruster is disposed on an upper-middle part of the body of the underwater inspection device, so that the underwater inspection device can move upward and downward.

Preferably, the attitude sensor includes a three-axis gyroscope, a three-axis accelerometer, and a three-axis magnetometer for acquiring the location, moving track, acceleration, spatial acceleration, and geomagnetic field vector of the underwater inspection device, to obtain a real-time motion attitude of the underwater inspection device.

The present invention further provides a filtering method of the attitude sensor on the underwater inspection device. The attitude sensor uses a proportion-integral-derivative (PID) controller to receive a control signal sent by the host computer, and detects a motion attitude of the underwater inspection device to obtain a measurement signal; and filters the control signal and/or the measurement signal by using a Kalman filter to output the acquired information.

Preferably, the Kalman filter filters the control signal and/or the measurement signal, including the following steps:

presetting a value of a posteriori estimate \hat{x}ₖ₋₁ of a multidimensional state vector including the control signal and/or the measurement signal and a value of a posteriori estimate covariance Pₖ₋₁;

when there is dynamic noise in the attitude sensor, respectively substituting the value of the multidimensional state vector \hat{x}ₖ₋₁ and the value of Pₖ₋₁ into equation 1 and equation 2 to obtain values of a prior estimate \hat{x}ₖ⁻ and a prior estimate error covariance Pₖ⁻ through calculation, where equation 1 and equation 2 are as follows:

\hat{X}ₖ⁻=A\hat{X}ₖ₋₁+BUₖ₋₁ (1)

Pₖ⁻=APₖ₋₁A^{t}+Q (2)

k is a time constant, μₖ₋₁ is the control signal and/or the measurement signal, A is a state-transition matrix, B is a control input matrix, A^{T} is a transposed matrix of A, and Q is a process excitation noise covariance matrix;

substituting the obtained values of the state prediction \hat{x}ₖ⁻ and the mean square error Pₖ⁻ into equation 3, equation 4, and equation 5 to obtain values of a filter gain Kₖ, a posteriori estimate \hat{x}ₖ, and a posteriori estimate error covariance Pₖ, where equation 3, equation 4, and equation 5 are as follows:

Kₖ=Pₖ⁻H^{T}(HPₖ⁻H^{T}+R)⁻¹ (3)

\hat{X}ₖ=\hat{X}ₖ⁻+Kₖ(zₖ−H\hat{X}ₖ⁻) (4)

Pₖ=(I−KₖH)Pₖ⁻ (5)

R is an observation noise covariance matrix, H is a constant matrix, and H^{T} is a transposed matrix of H; and

substituting the obtained values of the filter gain Kₖ, the filter estimate \hat{x}ₖ, and the mean square error matrix Pₖ into equation 1 and equation 2 to obtain values of a new state prediction \hat{x}ₖ⁻ and mean square error Pₖ⁻.

According to the technical solution of the present invention, the underwater inspection device detects underwater pipeline information in real time to promptly discover pipeline damage and leakage. This provides reference for further taking scientific and appropriate measures to prolong a pipeline service life. In addition, the underwater inspection device in the present invention features a long battery endurance, controllable working depth, and wide detection range.

### BRIEF DESCRIPTION OF THE DRAWINGS

FIG. 1 is a schematic principle diagram of an underwater inspection device according to the present invention.

Objective implementation, function features, and advantages of the present invention are further described with reference to the embodiments and the accompanying drawings.

### DETAILED DESCRIPTION

It should be understood that the specific embodiments described herein are merely used to explain the present invention but are not intended to limit the present invention.

The present invention is further described below with reference to the accompanying drawings.

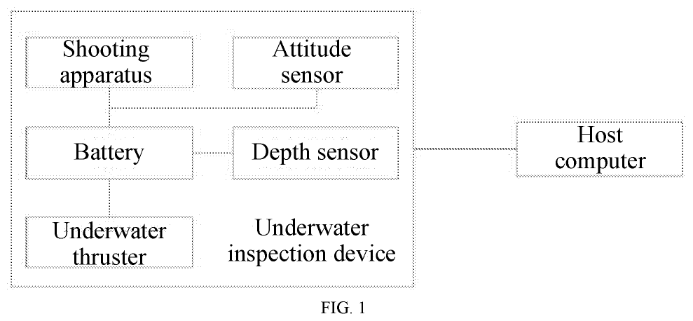

The present invention provides an underwater inspection device. As shown in FIG. 1, the underwater inspection device includes a shooting apparatus configured to acquire underwater pipeline image information. The underwater inspection device further includes an underwater thruster configured to provide impetus for the underwater inspection device, a depth sensor configured to detect an underwater depth, an attitude sensor configured to detect a three-dimensional motion attitude of the underwater inspection device, and an umbilical cable. The underwater inspection device is communicatively connected to a host computer through the umbilical cable to receive a control command sent by the host computer and send the acquired pipeline information to the host computer.

Preferably, the underwater inspection device includes a housing and a main control board and an expansion board that are disposed in the housing. The shooting apparatus is disposed on the main control board. The main control board and the shooting apparatus are disposed in a sealed tank. A battery configured to power the underwater inspection device is further disposed between the main control board and the expansion board. The battery is sealed in a battery compartment. Various sensors configured to detect a state of the underwater inspection device are disposed on the expansion board.

The main control board and the shooting apparatus are sealed in the tank by using a pressure-resistant and temperature-resistant sealing material and compound glue. This effectively ensures a good waterproof function of the main control board and the shooting apparatus. The battery sealed in the battery compartment can be replaced more flexibly and conveniently, ensuring that the underwater inspection device can continuously navigate underwater.

Preferably, the shooting apparatus is connected to the main control board by using a dual-axis digital steering engine. The dual-axis digital steering engine allows the shooting apparatus to implement 180° pitch rotation shooting, so that the underwater inspection device can comprehensively detect underwater pipeline conditions.

The shooting apparatus is disposed on the underwater inspection device. Driven by the underwater thruster, the underwater inspection device moves underwater, while the shooting apparatus shoots a real-time underwater environment. The camera is controlled to shoot at 180° pitch angle to detect underwater pipeline conditions in real time.

Preferably, the shooting apparatus includes an underwater camera, a highlight LED, and a laser probe.

In a specific embodiment, the underwater camera supports 12-megapixel autofocus with 1080P high-definition picture quality, wide-dynamic, low-illumination, and large-resolution technologies for Motion Joint Photographic Experts Group (MJPEG) video decoding, a plurality of hardware drives for cross-platform operations, a high-quality digital monolithic integrated circuit (MIC), and selection between single channel and dual channel. The highlight LED is disposed around the lens of the underwater camera to provide a light source for the underwater camera. Light intensity of the highlight LED can be easily adjusted by adjusting current strength. Working at low voltage and current, the highlight LED is shock-resistant, quakeproof, and highly reliable. Repeatedly switching the highlight LED on and off does not shorten its service life. The laser probe enables contactless long-distance measurement, thereby implementing underwater orientation.

Preferably, the depth sensor is communicatively connected to the expansion board through a serial port of a universal asynchronous transceiver. The depth sensor saves the acquired information to a read-only memory on the expansion board for sending to the host computer.

In a specific embodiment, the expansion board is Arduino Mega 2560, which is a microcontroller development board based on ATmega2560.

Preferably, the underwater thruster includes three groups of brushless motors and numerically controlled four-blade forward and reverse propellers connected to the brushless motors. The first group of the underwater thruster and the second group of the underwater thruster are disposed at the tail of the underwater inspection device, so that the underwater inspection device can move forward, backward, leftward, and rightward. The third group of the underwater thruster is disposed on an upper-middle part of the body of the underwater inspection device, so that the underwater inspection device can move upward and downward.

A controller of the brushless motor operates in a three-phase full-bridge pulse width modulation (PWM) chopping mode, and has a stable closed-loop speed. The motor can still maintain its rotation speed even with a heavy load. An automatic motor protection function is effectively implemented by using cycle current-limiting and an overvoltage/undervoltage apparatus. In this case, long-term use under severe conditions does not cause stall or stagnation.

Preferably, the attitude sensor includes a three-axis gyroscope, a three-axis accelerometer, and a three-axis magnetometer for acquiring the location, moving track, acceleration, spatial acceleration, and geomagnetic field vector of the underwater inspection device, to obtain a real-time motion attitude of the underwater inspection device.

The present invention further provides a filtering method of the attitude sensor on the underwater inspection device. The attitude sensor uses a PID controller to receive a control signal sent by the host computer, and detects a motion attitude of the underwater inspection device to obtain a measurement signal; and filters the control signal and/or the measurement signal by using a Kalman filter to output the acquired information.

Preferably, the Kalman filter filters the control signal and/or the measurement signal, including the following steps:

presetting a value of a posteriori estimate \hat{x}ₖ₋₁ of a multidimensional state vector including the control signal and/or the measurement signal and a value of a posteriori estimate covariance Pₖ₋₁;

when there is dynamic noise in the attitude sensor, respectively substituting the value of the multidimensional state vector \hat{x}ₖ₋₁ and the value of Pₖ₋₁ into equation 1 and equation 2 to obtain values of a prior estimate \hat{x}ₖ⁻ and a prior estimate error covariance Pₖ⁻ through calculation, where equation 1 and equation 2 are as follows:

\hat{X}ₖ⁻=A\hat{X}ₖ₋₁+BUₖ₋₁ (1)

Pₖ⁻=APₖ₋₁A^{T}+Q (2)

k is a time constant, μₖ₋₁ is the control signal and/or the measurement signal, A is a state-transition matrix, B is a control input matrix, A^{T} is a transposed matrix of A, and Q is a process excitation noise covariance matrix;

substituting the obtained values of the state prediction \hat{x}ₖ⁻ and the mean square error Pₖ⁻ into equation 3, equation 4, and equation 5 to obtain values of a filter gain Kₖ, a posteriori estimate \hat{x}ₖ, and a posteriori estimate error covariance Pₖ, where equation 3, equation 4, and equation 5 are as follows:

Kₖ=Pₖ⁻H^{T}(HPₖ⁻H^{T}+R)⁻¹ (3)

\hat{X}ₖ=\hat{X}ₖ⁻+Kₖ(zₖ−H\hat{X}ₖ⁻) (4)

Pₖ=(I−KₖH)Pₖ⁻ (4)

R is an observation noise covariance matrix, H is a constant matrix, and H^{T} is a transposed matrix of H; and

substituting the obtained values of the filter gain Kₖ, the filter estimate \hat{x}ₖ, and the mean square error matrix Pₖ into equation 1 and equation 2 to obtain values of a new state prediction \hat{x}ₖ⁻ and mean square error Pₖ⁻.

In this embodiment, the Kalman filtering method and the conventional PID algorithm are combined to control the stability of the underwater robot. The covariance value is continuously updated and corrected to continuously obtain system measurement values. The covariance is continuously recursive so that an optimal estimate value is obtained. In this case, a real-time motion attitude of a module can be solved accurately and quickly in a dynamic environment. In addition, measurement noise is reduced, and measurement accuracy is improved.

It should be understood that the foregoing descriptions are merely example embodiments of the present invention, and the protection scope of the present invention is not limited thereto. All equivalent structure or process changes made according to the content of the specification and accompanying drawings in the present invention or by directly or indirectly applying the present invention in other related technical fields shall fall within the protection scope of the present invention.

1. An underwater inspection device, comprising a shooting apparatus configured to acquire underwater pipeline image information, and further comprising an underwater thruster configured to provide impetus for the underwater inspection device, a depth sensor configured to detect an underwater depth, an attitude sensor configured to detect a three-dimensional motion attitude of the underwater inspection device, and an umbilical cable; wherein the underwater inspection device is communicatively connected to a host computer through the umbilical cable to receive a control command sent by the host computer and send the acquired pipeline information to the host computer.

2. The underwater inspection device according to claim 1, wherein the underwater inspection device further comprises a housing and a main control board and an expansion board that are disposed in the housing; the shooting apparatus is disposed on the main control board; the main control board and the shooting apparatus are disposed in a sealed tank; a battery configured to power the underwater inspection device is further disposed between the main control board and the expansion board, and the battery is sealed in a battery compartment; and various sensors configured to detect a state of the underwater inspection device are disposed on the expansion board.

3. The underwater inspection device according to claim 2, wherein the shooting apparatus is connected to the main control board by using a dual-axis digital steering engine.

4. The underwater inspection device according to claim 3, wherein the shooting apparatus comprises an underwater camera, a highlight LED, and a laser probe.

5. The underwater inspection device according to claim 2, wherein the depth sensor is communicatively connected to the expansion board through a serial port of a universal asynchronous transceiver, and the depth sensor saves the acquired information to a read-only memory on the expansion board for sending to the host computer.

6. The underwater inspection device according to claim 1, wherein the underwater thruster comprises three groups of brushless motors and numerically controlled four-blade forward and reverse propellers connected to the brushless motors; the first group of the underwater thruster and the second group of the underwater thruster are disposed at the tail of the underwater inspection device, so that the underwater inspection device can move forward, backward, leftward, and rightward; and the third group of the underwater thruster is disposed on an upper-middle part of the body of the underwater inspection device, so that the underwater inspection device can move upward and downward.

7. The underwater inspection device according to claim 1, wherein the attitude sensor comprises a three-axis gyroscope, a three-axis accelerometer, and a three-axis magnetometer for acquiring the location, moving track, acceleration, spatial acceleration, and geomagnetic field vector of the underwater inspection device, to obtain a real-time motion attitude of the underwater inspection device.

8. A filtering method of the attitude sensor on the underwater inspection device according to claim 7, wherein the attitude sensor uses a proportion-integral-derivative (PID) controller to receive a control signal sent by the host computer, and detects a motion attitude of the underwater inspection device to obtain a measurement signal; and filters the control signal and/or the measurement signal by using a Kalman filter to output the acquired information.

9. The filtering method according to claim 8, wherein the Kalman filter filters the control signal and/or the measurement signal, comprising the following steps:
presetting a value of a posteriori estimate \hat{x}ₖ₋₁ of a multidimensional state vector comprising the control signal and/or the measurement signal and a value of a posteriori estimate covariance Pₖ₋₁;
when there is dynamic noise in the attitude sensor, respectively substituting the value of the multidimensional state vector \hat{x}ₖ₋₁ and the value of Pₖ₋₁ into equation 1 and equation 2 to obtain values of a prior estimate \hat{x}ₖ⁻ and a prior estimate error covariance Pₖ⁻ through calculation, wherein equation 1 and equation 2 are as follows:
\hat{X}ₖ⁻=A\hat{X}ₖ₋₁+BUₖ₋₁ (1)
Pₖ⁻=APₖ₋₁A^{T}+Q (2)
k is a time constant, μₖ₋₁ is the control signal and/or the measurement signal, A is a state-transition matrix, B is a control input matrix, A^{T} is a transposed matrix of A, and Q is a process excitation noise covariance matrix;
substituting the obtained values of the state prediction \hat{x}ₖ⁻ and the mean square error Pₖ⁻ into equation 3, equation 4, and equation 5 to obtain values of a filter gain Kₖ, a posteriori estimate \hat{x}ₖ, and a posteriori estimate error covariance Pₖ, wherein equation 3, equation 4, and equation 5 are as follows:
Kₖ=Pₖ⁻H^{T}(HPₖ⁻H^{T}+R)⁻¹ (3)
\hat{X}ₖ=\hat{X}ₖ⁻+Kₖ(zₖ−H\hat{x}ₖ⁻) (4)
Pₖ=(I−KₖH)Pₖ⁻ (5)
R is an observation noise covariance matrix, H is a constant matrix, and H^{T} is a transposed matrix of H; and
substituting the obtained values of the filter gain Kₖ, the filter estimate \hat{x}ₖ, and the mean square error matrix Pₖ into equation 1 and equation 2 to obtain values of a new state prediction \hat{x}ₖ⁻ and mean square error Pₖ⁻.
